(19) United States
(12) Patent Application Publication
(10) Pub. No.: US 2014/0156338 A1
(43) Pub. Date: Jun. 5, 2014

(54) INFORMATION PROCESSING APPARATUS AND METHOD AND NON-TRANSITORY COMPUTER READABLE MEDIUM

(71) Applicant: FUJI XEROX CO., LTD., Tokyo (JP)

(72) Inventors: Tomoyuki ITO, Kanagawa (JP); Satoru INAKAGE, Kanagawa (JP); Michiaki YASUNO, Kanagawa (JP); Hiroshi UMEMOTO, Kanagawa (JP); Nobuyuki NAKAYAMA, Kanagawa (JP); Yoichi WATANABE, Kanagawa (JP)

(73) Assignee: Fuji Xerox Co., Ltd., Tokyo (JP)

(21) Appl. No.: 13/874,880

(22) Filed: May 1, 2013

(30) Foreign Application Priority Data
Dec. 5, 2012 (JP) 2012-266805

(51) Int. Cl. G06Q 10/06

(52) U.S. Cl. CPC G06Q 10/0633
USPC 705/7.27

(57) ABSTRACT

An information processing apparatus includes the following elements. An axis-name setting unit sets names of first through fourth axes. An item forming unit forms an item associated with an axis for which a name is set by the axis-name setting unit. A display displays a QFD chart used for developing a product, in which the names of the first through fourth axes are deployed in a region divided into top, bottom, right, and left sections from a center of the QFD chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis.

### CROSS-REFERENCE TO RELATED APPLICATIONS

This application is based on and claims priority under 35 USC 119 from Japanese Patent Application No. 2012-266805 filed Dec. 5, 2012.

### BACKGROUND

### Technical Field

The present invention relates to an information processing apparatus and method, and a non-transitory computer readable medium.

### SUMMARY

According to an aspect of the invention, there is provided an information processing apparatus including: an axis-name setting unit that sets names of first through fourth axes; an item forming unit that forms an item associated with an axis for which a name is set by the axis-name setting unit; and a display that displays, on the basis of the names of the first through fourth axes set by the axis-name setting unit and the items formed by the item forming unit, a QFD chart used for developing a product, in which the names of the first through fourth axes are deployed in a region divided into top, bottom, right, and left sections from a center of the QFD chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis. The item forming unit forms items associated with the first through fourth axes as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

### BRIEF DESCRIPTION OF THE DRAWINGS

An exemplary embodiment of the present invention will be described in detail based on the following figures, wherein:

FIG. 1 is a block diagram illustrating conceptual modules of an example of the configuration of an exemplary embodiment;

FIG. 2 is a flowchart illustrating an example of processing according to this exemplary embodiment;

FIG. 3 illustrates an example of the data structure of an axis item table;

FIG. 4 illustrates an example of processing for displaying and selecting axis names;

FIG. 5 illustrates an example of processing for displaying and selecting axis items;

FIG. 6 illustrates a display example of a selected axis name and selected items;

FIG. 7 illustrates a display example of a parts/members QFD chart;

FIG. 8 illustrates a display example of a system QFD chart;

FIG. 9 is a flowchart illustrating another example of processing according to this exemplary embodiment; and

FIG. 10 illustrates an example of the hardware configuration of a computer implementing this exemplary embodiment.

### DETAILED DESCRIPTION

Prior to a description of an exemplary embodiment of the present invention, a technology which is a base of this exemplary embodiment will first be discussed. This discussion will be given for the purpose of easy understanding of this exemplary embodiment.

As the structure of a technology or a product becomes complicated, the number of cause-and-effect relationships between factors forming the technology or the product becomes increasing, and also, the cause-and-effect relationships are interacted with each other. It is thus difficult to understand the associations between factors. This may bring about the following problems.

(1) It takes time to find cause-and-effect relationships between factors of a technology or a product, thereby decreasing the efficiency in designing and developing the technology or the product.

(2) It is more likely to overlook a problem, and when a problem is found, a designing or developing process has to be suspended and reexamined.

(3) If manufacturing of a product continues without realizing the existence of a problem, quality problems occur.

(4) If an unexpected problem occurs, it takes time to construct a technology for analyzing a phenomenon of the problem, which causes a delay in addressing the problem.

One of the measures to be taken against the above-described problems which may effectively function is a method of analyzing and visualizing factors based on Quality Function Deployment (QFD).

QFD is a method for clarifying targets, problems, and actions to be taken so that customer/client requirements in terms of the quality can be reflected in product manufacturing in various stages, such as product planning, product developing, etc.

A typical form of QFD is a matrix indicating relationships between items of “quality requirements” extracted from items of customer/client requirements and items of “quality characteristics” extracted from factors to be considered in terms of a technology. QFD may also represent relationships between items of “quality requirements” or items of “quality characteristics” in the form of a triangle attic. By applying weights to items of “quality requirements”, items of “planning requirements” (indicating which characteristics will satisfy customers/clients) may be extracted. Also, by associating items of “quality characteristics” with product design values, items of “design requirements” (product specifications) can be extracted. As a result of examining the above-described relationships, relationships among targets, problems, and actions to be taken can be clarified. That is, a QFD chart is a chart in which plural item lists are deployed on axes orthogonal to each other and cause-and-effect relationships between items on adjacent axes are represented in the form of a matrix.

In order to improve QFD, the following proposal has been made. Not only the use of items of “quality requirements” and “quality characteristics”, but also various deployments, such as “parts deployment”, “technology deployment”, and “task deployment”, are performed according to the circumstances, and then, obtained cause-and-effect relationships between items are represented by two-dimensional tables. Moreover, a computer program for displaying these tables is produced, and the items and matrix cells are linked to information on a network, thereby utilizing QFD as a frame for storing and sharing information.

However, some products, such as printers and medical instruments, function in a complicated manner such that many parts/members and plural physical phenomena are interrelated with each other. In the development of such a product, there are a huge number of items to be handled, and also, it is difficult to sufficiently describe relationships between design characteristics and quality requirements by using a simple frame, such as a combination of “quality requirements” and “quality characteristics” or a combination of “parts deployment” and “technology deployment”. Moreover, a process for manufacturing a product is established in coordination of many departments, such as technology development, parts/members development, system development, and manufacturing departments. Accordingly, two-dimensional tables may be created, and symbols representing that “these items may be related” and “these items may not be related” may be assigned. However, unless the entire relationships between design characteristics and quality requirements including a mechanism of a phenomenon “why these items may be related” or “why these items may not be related” can be understood at a glance, it is difficult to utilize QFD in an actual designing and developing process. That is, the manufacturing steps for parts and members and the quality of a manufactured product are indirectly related to each other with various intermediate characteristics therebetween. Unless tables having appropriate intermediate characteristics and configurations are provided, it is difficult to clarify relationships between the manufacturing steps and the quality. The product design conditions and the product quality are also indirectly related to each other with various intermediate characteristics therebetween. Unless tables having appropriate intermediate characteristics and configurations are provided, it is difficult to clarify the true relationships between the design conditions and the quality.

Additionally, in many cases, the definition of intermediate characteristics is ambiguous, which makes it difficult to standardize QFD charts. As a result, the use of QFD charts in an actual designing and developing process has not been promoted.

An exemplary embodiment of the present invention will be described below with reference to the accompanying drawings.

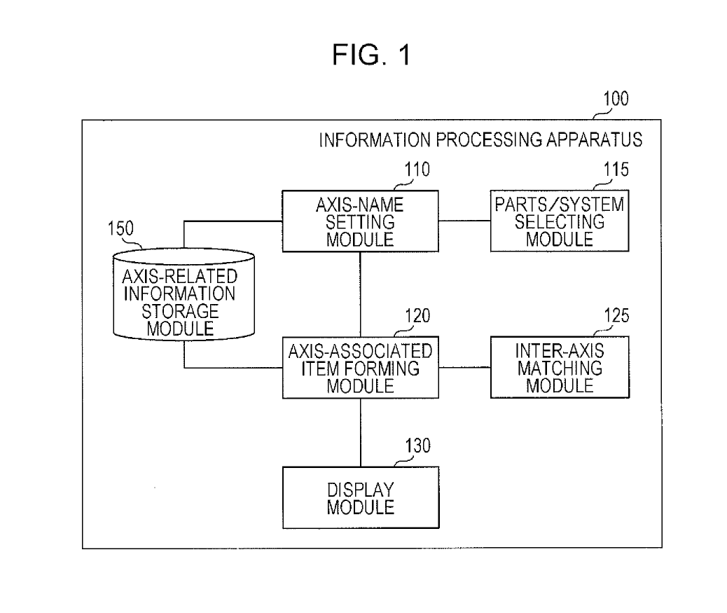

FIG. 1 is a block diagram illustrating conceptual modules forming an information processing apparatus 100 according to this exemplary embodiment.

Generally, modules are software (computer programs) components or hardware components that can be logically separated from one another. Accordingly, the modules of this exemplary embodiment of the invention are not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether case A is satisfied, and B is performed if it is determined that case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk, a random access memory (RAM), an external storage medium, a storage device using a communication line, a register within a central processing unit (CPU), etc.

The information processing apparatus 100 of this exemplary embodiment includes, as shown in FIG. 1, an axis-name setting module 110, a parts (members)/system selecting module 115 (hereinafter simply referred to as “parts/system selecting module 115”), an axis-associated item forming module 120, an inter-axis matching module 125, a display module 130, and an axis-related information storage module 150.

The information processing apparatus 100 is utilized for supporting design and development in order to improve the efficiency in developing technologies and products and also to enhance the qualities of technologies and products.

The parts/system selecting module 115 is connected to the axis-name setting module 110. The parts/system selecting module 115 is used for selecting the type of QFD chart to be formed, and more specifically, the parts/system selecting module 115 selects one of (1) a QFD chart for clarifying relationships between the manufacturing steps for parts and members and the quality of a product obtained by assembling these parts or members (hereinafter may also be referred to as a “parts/members QFD chart”) and (2) a QFD chart for clarifying relationships between the design conditions in developing a technology or a product and the quality of the technology or the product (hereinafter may also be referred to as a “system QFD chart”). The names of axes and items associated with the axes, which will be discussed later, will be different depending on which of the parts/members QFD chart and the system QFD chart is selected. In this case, an operator may select the type of QFD chart by performing a selecting operation. Alternatively, the type of QFD chart may be selected according to an operator, or the department or the job type of an operator. For example, a table in which operator identifiers for uniquely identifying operators in this exemplary embodiment are individually associated with the parts/members QFD chart or the system QFD chart may be prepared and stored in the axis-related information storage module 150, and by using this table, the type of QFD chart may be selected from an operator identifier. Alternatively, a table in which operators are individually associated with departments or job types, and a table in which departments or job types are individually associated with the parts/members QFD chart or the system QFD chart may be prepared and stored in the axis-related information storage module 150. By using these two tables, the QFD chart may be selected from an operator identifier for uniquely identifying an associated operator.

The axis-name setting module 110 is connected to the parts/system selecting module 115, the axis-associated item forming module 120, and the axis-related information storage module 150. The axis-name setting module 110 sets names of first through fourth axes. In this case, the concept of setting of the names of axes includes generating of the names of axes. The axis-name setting module 110 may set the names of the first through fourth axes on the basis of a selection result of the parts/system selecting module 115. That is, if the parts/members QFD chart has been selected by the parts/system selecting module 115, the axis-name setting module 110 may set “quality” as the name of the first axis, “performance” as the name of the second axis, “structures and physical properties” as the name of the third axis, and “production conditions” as the name of the fourth axis. If the system QFD chart has been selected by the parts/system selecting module 115, the axis-name setting module 110 may set “quality” as the name of the first axis, “mechanism” as the name of the second axis, “physical characteristics” as the name of the third axis, and “design conditions” as the name of the fourth axis.

The axis-associated item forming module 120 is connected to the axis-name setting module 110, the inter-axis matching module 125, the display module 130, and the axis-related information storage module 150. The axis-associated item forming module 120 forms, through a selecting operation performed by an operator, items associated with axes for which names are set by the axis-name setting module 110. The axis-associated item forming module 120 forms (1) items indicating quality requirements of a product, as items associated with the first axis, (2) items indicating performance capabilities provided by the individual parts and members in order to satisfy the quality requirements of the product, as items associated with the second axis, (3) items concerning the structures and the physical properties of the individual parts and members, as items associated with the third axis, and (4) items which define production conditions for the individual parts and members, as items associated with the fourth axis.

Particularly when the parts/members QFD chart is selected by the parts/system selecting module 115, the axis-associated item forming module 120 may form, through a selecting operation performed by an operator, (1) items indicating quality requirements of a product, as items associated with the first axis, (2) items indicating performance capabilities provided by the individual parts and members in order to satisfy the product quality requirements, as items associated with the second axis, (3) items concerning the structures and the physical properties of the individual parts and members, as items associated with the third axis, and (4) items which define production conditions for the individual parts and members, as items associated with the fourth axis.

Alternatively, particularly when the system QFD chart is selected by the parts/system selecting module 115, the axis-associated item forming module 120 may form, through a selecting operation performed by an operator, (1) items indicating quality requirements of a product, as items associated with the first axis, (2) items concerning a physical mechanism whose behavior is determined by items of physical characteristics and which dominates the quality of the product, as items associated with the second axis, (3) items indicating system physical characteristics determined by design conditions, as items associated with the third axis, and (4) items indicating design conditions, as items associated with the fourth axis. Additionally, as items associated with each of the first through fourth axes, in addition to the individual parts and members, “all parts/members” (large classification of items) indicating items applicable to all the parts/members may be included.

The axis-associated item forming module 120 may cause the inter-axis matching module 125 to determine consistencies of the items formed by the axis-associated item forming module 120 between different axes.

There may be certain items which are difficult to classify into an exact item in each axis, for example, items applicable to all the parts/members, system parameters, and external disturbance. The axis-associated item forming module 120 may form such items such that they are deployed in parallel with the items of the associated axes.

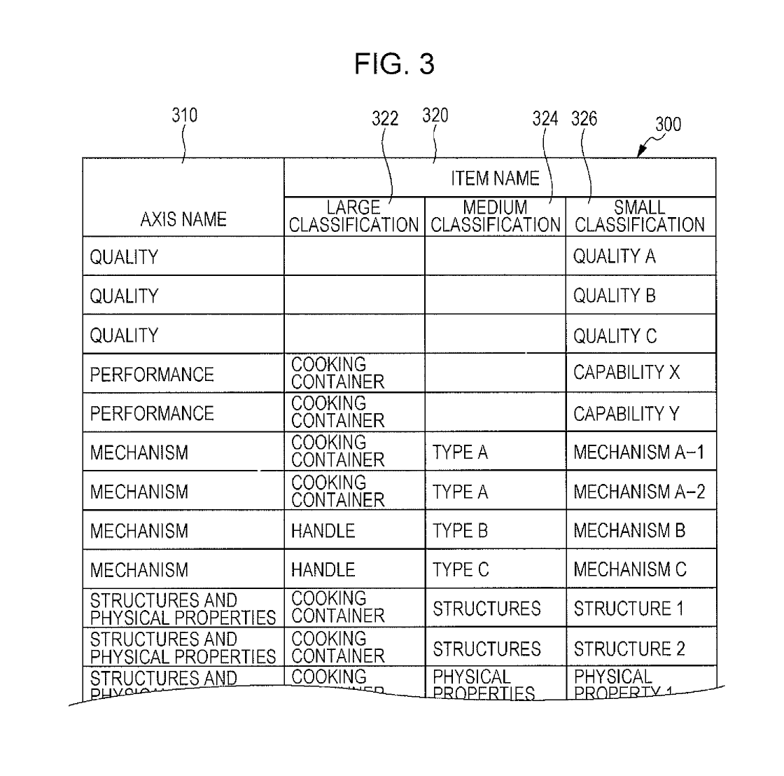

Items associated with the axes may have a hierarchical structure having at least one level, such as an axis item table 300 shown in FIG. 3. FIG. 3 shows an example of the data structure of the axis item table 300. The axis item table 300 includes an axis name column 310 and an item name column 320. In the axis name column 310 stores therein names of axes. The item name column 320 stores therein item names associated with the axes. The items have a hierarchical structure having, for example, three levels, such as large, medium, and small classifications. The item name column 320 includes a large classification column 322, a medium classification column 324, and a small classification column 326. The large classification column 322 stores therein, as the first level, items classified under the large classification. The medium classification column 324 stores therein, as the second level, items classified under the medium classification. The small classification column 326 stores therein, as the third level, items classified under the small classification. The hierarchical structure may have only one level having a small classification, two levels having large and small classifications, and three levels having large, medium, and small classifications.

The inter-axis matching module 125 is connected to the axis-associated item forming module 120. The inter-axis matching module 125 determines whether there is a consistency of items of a predetermined hierarchical level at least between the first and second axes, the second and third axes, and the third and fourth axes. If the inter-axis matching module 125 determines that there is no consistency of items, it may correct a corresponding item. In this case, corrections may be made automatically or in accordance with an operation of an operator (for example, correction patterns are shown and an operator is instructed to select one of the correction patterns, or a warning is issued and an operator is instructed to correct an item).

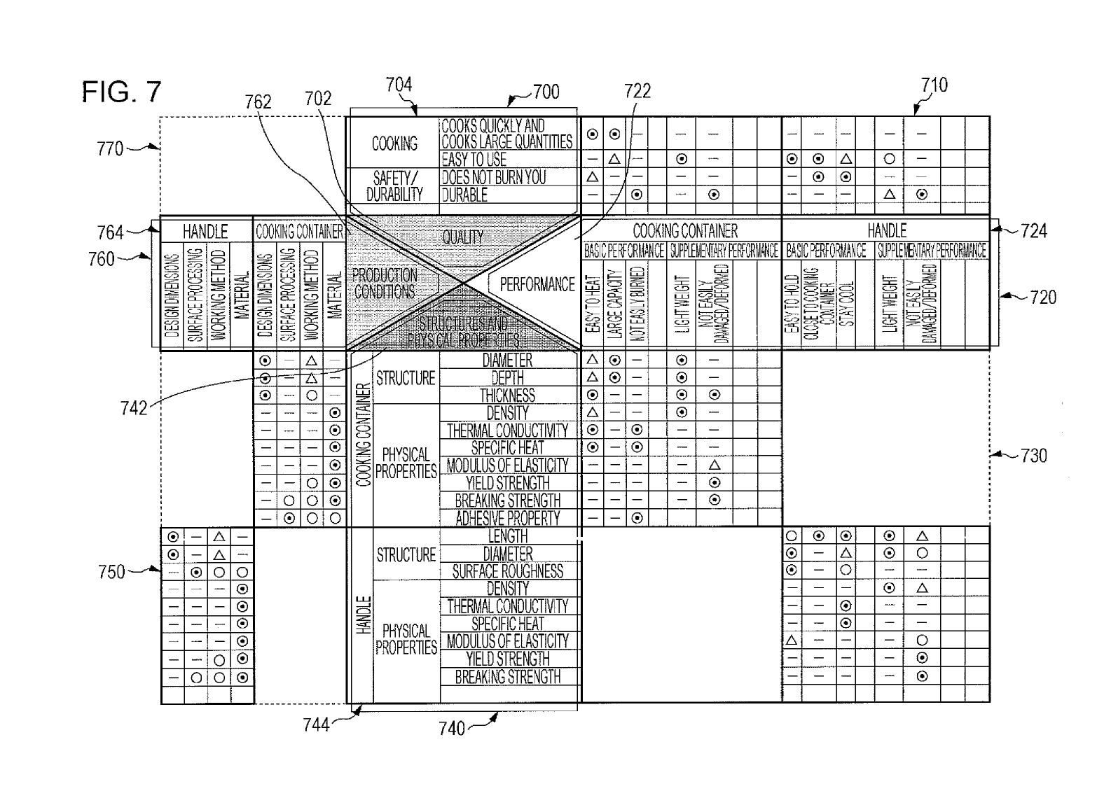

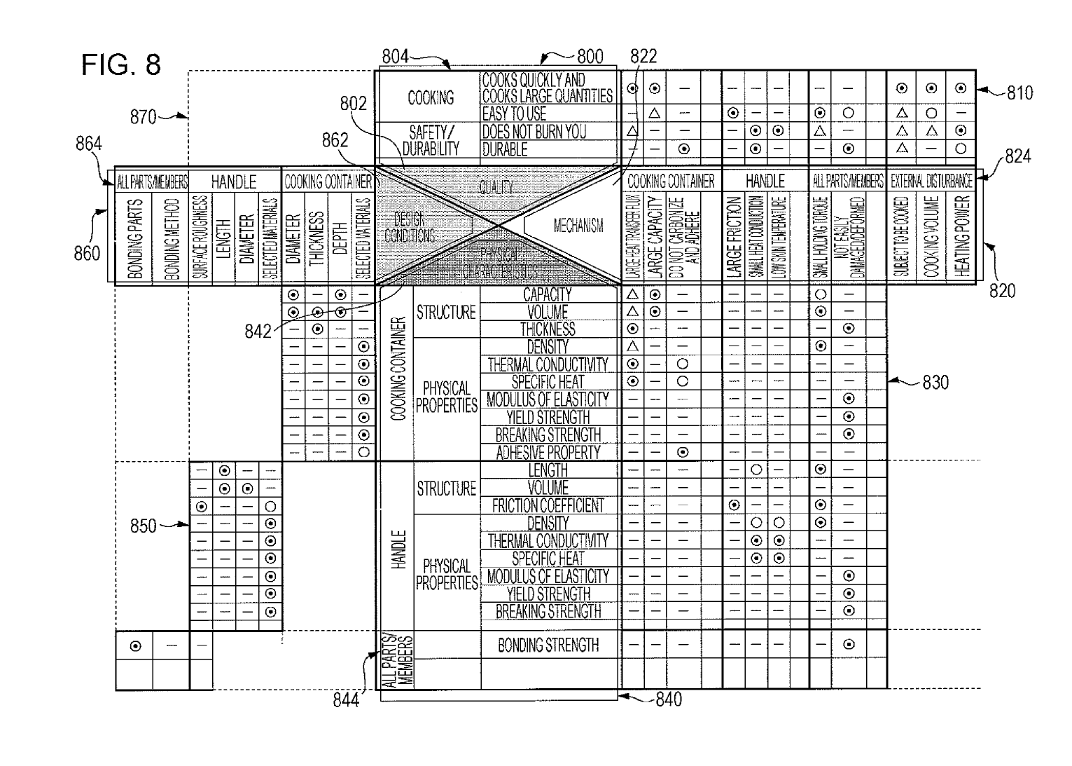

The display module 130 is connected to the axis-associated item forming module 120. On the basis of the names of the axes set by the axis-name setting module 110 and the items formed by the axis-associated item forming module 120, the display module 130 displays a QFD chart used for developing a product, in which the names of the first through fourth axes are deployed within a region divided into top, bottom, right and left sections from the center of the QFD chart, the items associated with the first through fourth axes are deployed in the directions extending upward, downward, rightward, and leftward from the center, and matrices into which cause-and-effect relationships between associated items may be input are deployed at least between the first and second axes, the second and third axes, and the third and fourth axes. The QFD chart displayed by the display module 130 may be a parts/members QFD chart, such as that shown in FIG. 7, or a system QFD chart, such as that shown in FIG. 8, which will be discussed later.

The axis-related information storage module 150 is connected to the axis-name setting module 110 and the axis-associated item forming module 120. The axis-related information storage module 150 stores therein information related to axes, for example, the axis item table 300 shown in FIG. 3.

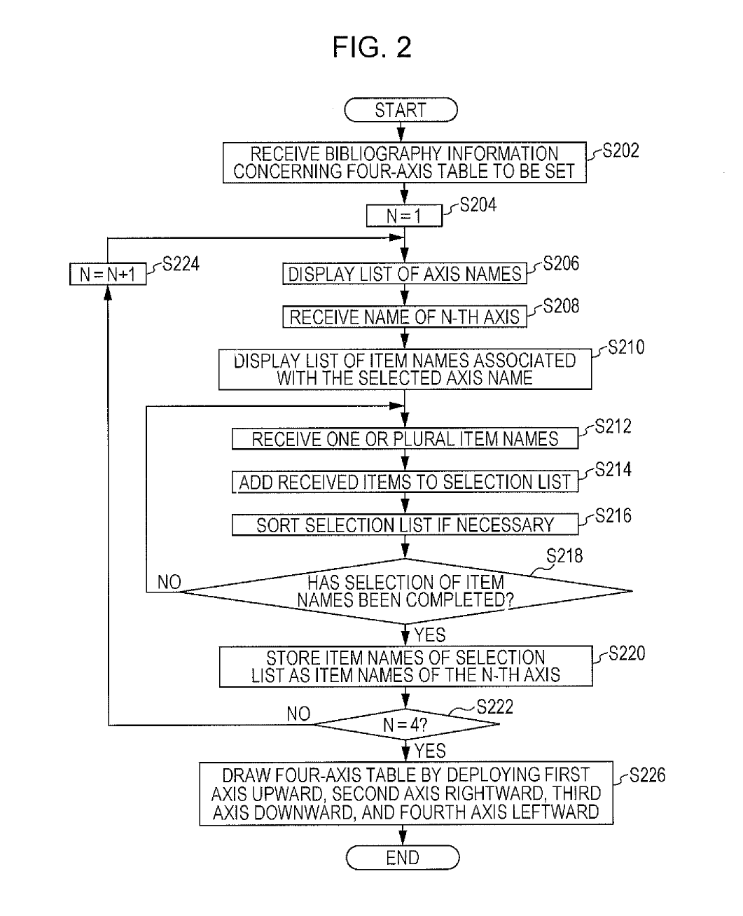

FIG. 2 is a flowchart illustrating an example of processing according to this exemplary embodiment.

In step S202, the axis-name setting module 110 receives bibliography information concerning a four-axis table to be set. Examples of the bibliography information are an operator name, an operator identifier, the date and time at which a table is created, and a product name.

In step S204, the axis-name setting module 110 sets a variable N to be 1 (N=1). The variable N is a value indicating an axis number.

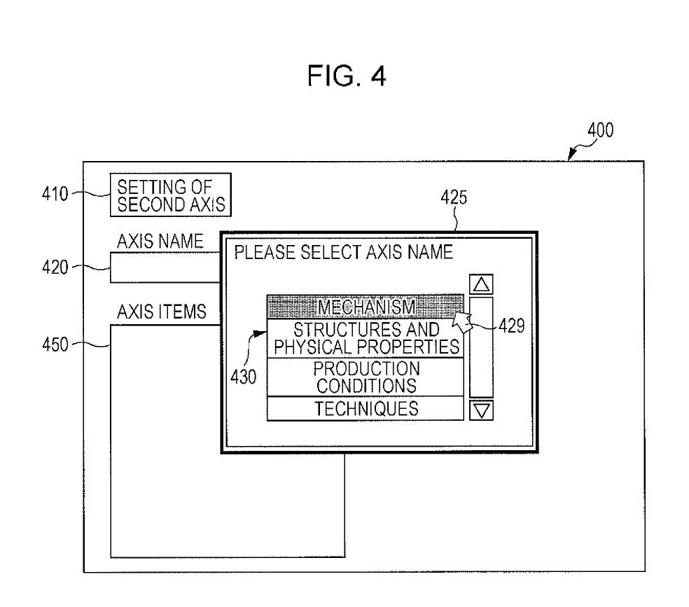

In step S206, the axis-name setting module 110 displays a list of axis names. FIG. 4 shows an example of processing for displaying and selecting axis names. On a setting screen 400, such as a liquid crystal display, provided in the information processing apparatus 100, an N-th axis setting column 410, an axis-name setting column 420, and an axis-item setting column 450 are displayed. The N-th axis setting column 410 displays a currently selected axis, i.e., an N-th axis, in accordance with the value of the variable N set in step S204 or S224. When an operator selects the axis-name setting column 420 by performing a selecting operation, an axis-name selecting area 425 including an axis-name list display area 430 is displayed. Then, the operator is instructed to select one of the axis names displayed in the axis-name list display area 430 by using a cursor 429. The axis names within the axis-name list display area 430 may be extracted from the axis name column 310 of the axis item table 300.

In step S208, the axis-name setting module 110 receives a name of the N-th axis.

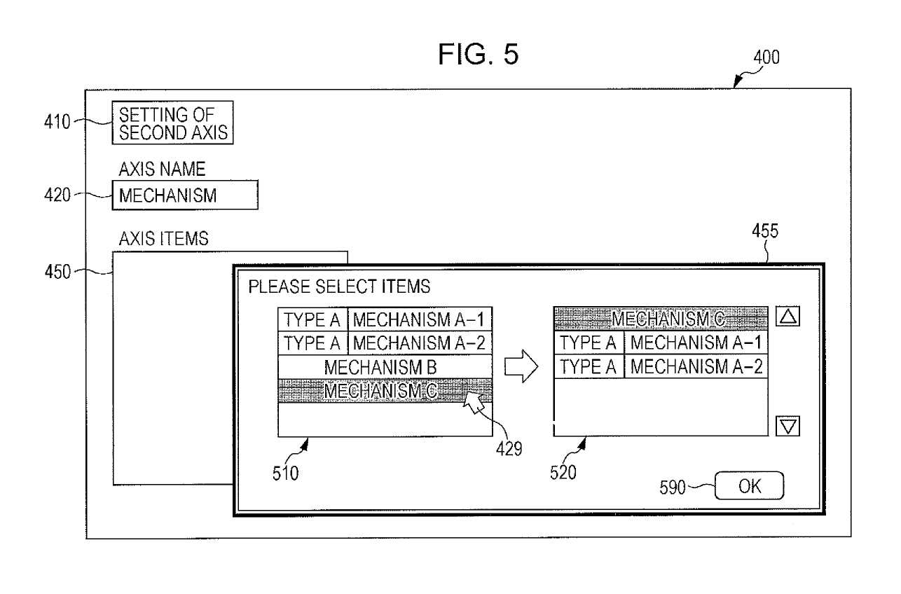

In step S210, the axis-associated item forming module 120 displays a list of item names associated with the selected axis name. FIG. 5 shows an example of processing for displaying and selecting axis items. On the setting screen 400, the N-th axis setting column 410, the axis-name setting column 420, and the axis-item setting column 450 are displayed. When the operator selects the axis-item setting column 450 by performing a selecting operation, an item selecting area 455 including an item selecting table 510 and a selection-result display table 520 is displayed. When the operator selects an item within the item selecting table 510 by using the cursor 429, the selected item is moved to the selection-result display table 520 and is displayed. The item names within the item selecting table 510 may be extracted from the item name column 320 of the axis item table 300.

In step S212, the axis-associated item forming module 120 receives one or plural item names.

In step S214, the axis-associated item forming module 120 adds the received items to a selection list.

In step S216, if necessary, the axis-associated item forming module 120 sorts the selection list. For example, items in the selection list may be sorted in accordance with the order of items of an axis for which items have already been selected.

In step S218, the axis-associated item forming module 120 determines whether the selection of item names has been completed. If the result of step S218 is YES, the process proceeds to step S220. If the result of step S218 is NO, the process returns to step S212. For example, if an OK button 590 displayed within the item selecting area 455 shown in FIG. 5 is operated by the operator, the axis-associated item forming module 120 determines that the selection of item names has been completed.

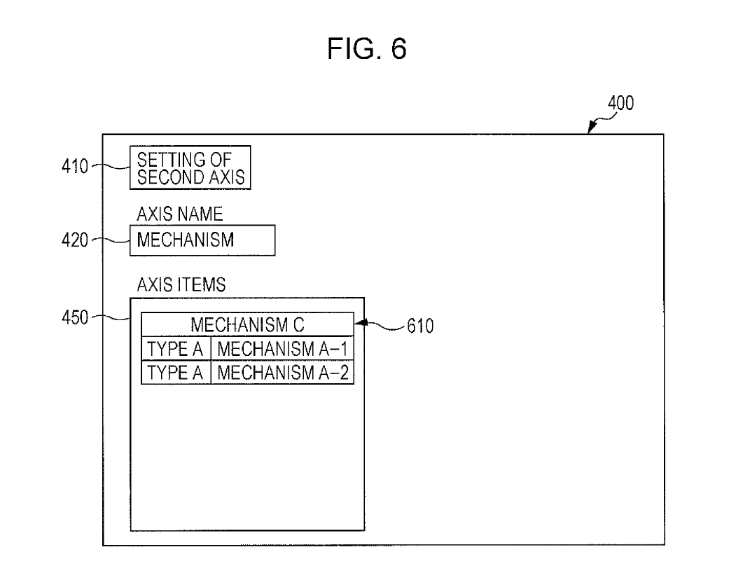

In step S220, the axis-associated item forming module 120 stores the item names of the selection list in the axis-related information storage module 150 as the item names of the N-th axis. FIG. 6 shows a display example of the selected axis name and the selected items. A currently selected axis is displayed in the N-th axis setting column 410, the name of the axis is displayed in the axis-name setting column 420, and an axis/item setting result table 610 is displayed in the axis-item setting column 450. A combination of the N-th axis setting column 410, the axis-name setting column 420, and the axis/item setting result table 610 is stored in the axis-related information storage module 150.

In step S222, the axis-associated item forming module 120 determines whether N is four. If the result of step S222 is YES, the process proceeds to step S226. If the result of step S222 is NO, the process proceeds to step S224.

In step S224, the axis-name setting module 110 increments N by one (N=N+1).

In this example of processing, the first through fourth axes are sequentially received. However, the operator may select, as desired, axis numbers to which axis names and items associated with the axes are to be appended.

In step S226, the display module 130 draws a four-axis table by deploying the first axis upward, the second axis rightward, the third axis downward, and the fourth axis leftward.

For example, the four-axis table may be displayed as the parts/members QFD chart shown in FIG. 7 or the system QFD chart shown in FIG. 8.

In the example shown in FIG. 7, four axes (a quality axis (first axis) 700, a performance axis (second axis) 720, a structures/physical-properties axis (third axis) 740, and a production-conditions axis (fourth axis) 760) are shown. The names of the individual axes are displayed in end triangular portions of the four axes 700, 720, 740, and 760, which are an axis-name display area (quality) 702, an axis-name display area (performance) 722, an axis-name display area (structures and physical properties) 742, and an axis-name display area (production conditions) 762. Items associated with the quality axis (first axis) 700 are displayed in an item-name display area 704 extending upward from the axis-name display area 702. Items associated with the performance axis (second axis) 720 are displayed in an item-name display area 724 extending rightward from the axis-name display area 722. Items associated with the structures/physical-properties axis (third axis) 740 are displayed in an item-name display area 744 extending downward from the axis-name display area 742. Items associated with the production-conditions axis (fourth axis) 760 are displayed in an item-name display area 764 extending leftward from the axis-name display area 762. Then, at least in three areas, that is, in an item-correlation area 710 between the item-name display areas 704 and 724, in an item-correlation area 730 between the item-name display areas 724 and 744, and in an item-correlation area 750 between the item-name display areas 744 and 764, matrices are generated. In these matrices, for example, in a matrix generated in the item-correlation area 710, at a position at which two associated items displayed in the item-name display areas 704 and 724 intersect with each other, a cause-and-effect relationship between these two items may be input. For example, at a position between an item “does not burn you” of “safety/durability” in the item-name display area 704 and an item “stay cool” of “basic performance” of “handle” in the item-name display area 724, a symbol ⊙ indicating a strong correlation is input. The correlation between two associated items may be represented by a numeric value, a color, or a combination thereof. For example, if a positive correlation is indicated by a red symbol and a negative correlation is indicated by a blue symbol, signs (+ and −) of a correlation may also be indicated, in addition to the strength of a correlation. In an item-correlation area 770 between the item-name display areas 704 and 764, a matrix into which cause-and-effect relationships between items in the item-correlation areas 704 and 764 may be input may be generated. In this parts/members QFD chart, influences of “production conditions” on “quality” can be examined from the relationships between “production conditions” and “structures and physical properties”, the relationships between “structures and physical properties” and “performance”, and between “performance” and “quality”. That is, the information processing apparatus 100 of this exemplary embodiment makes it easier to clarify a mechanism for obtaining a certain result, i.e., “quality” (phenomenon), from “production conditions” through “structures and physical properties” and “performance”, than the use of information processing apparatuses other than this exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand the mechanism of functions of individual parts and members. By checking for portions of the matrix into which an operator is unable to input a symbol, a numeric value, etc., indicating a relationship between items, necessary analytic techniques can be extracted.

Generally, the factors indicated in the individual axes are handled by different departments, and thus, collaboration between different departments can be promoted.

The example shown in FIG. 8 is similar to that shown in FIG. 7. However, since the example shown in FIG. 8 concerns a system QFD chart, it has an item “all parts/members” in addition to items concerning individual parts and members, as stated above. By using this system QFD chart, influences of “design conditions” on “quality” can be examined from the relationships between “design conditions” and “physical characteristics”, the relationships between “physical characteristics” and “mechanism”, and the relationships between “mechanism” and “quality”. That is, the information processing apparatus 100 of this exemplary embodiment makes it easier to clarify a mechanism for obtaining a certain result, i.e., “quality” (phenomenon), from “design conditions” through “physical characteristics” and “mechanism”, than the use of information processing apparatuses other than this exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand a physical mechanism in which characteristics determined by design conditions influence the quality. By checking for portions of the matrix into which an operator fails to input a symbol, a numeric value, etc., indicating a relationship between items, necessary analytic techniques can be extracted.

After an operator has input symbols, numeric values, etc. indicating correlations between items, if there are some portions of matrices into which symbols, numeric values, etc. are not input, the display module 130 may display information that there are some items for which correlations are not indicated. For example, such portions of the matrices may be displayed in a color different from the color of the other portions of the matrices in which correlations are indicated.

Additionally, items of a matrix concerning the third axis into which correlations are not indicated may be extracted, and the display module 130 may indicate that such items are included as items of “structures/physical-properties” in association with “performance” but correlations are not indicated because of an insufficient measurement technique.

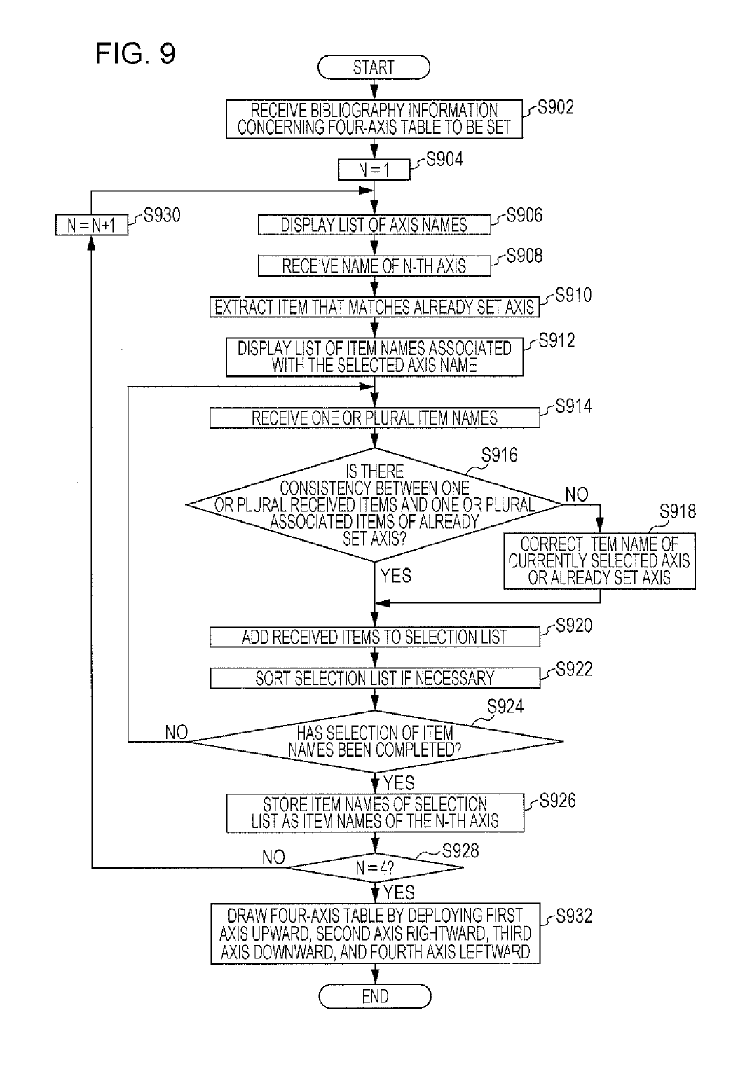

FIG. 9 is a flowchart illustrating another example of processing according to this exemplary embodiment. In this flowchart, steps S910, S916, and S918 are added to the steps of the flowchart in FIG. 2. Details of steps S910, S916, and S918 will be given. The other steps are similar to those in FIG. 2.

In step S902, the axis-name setting module 110 receives bibliography information concerning a four-axis table to be set.

In step S904, the axis-name setting module 110 sets a variable N to be 1 (N=1).

In step S906, the axis-name setting module 110 displays a list of axis names.

In step S908, the axis-name setting module 110 receives a name of the N-th axis.

In step S910, an item that matches a certain item of an axis for which items have already been set is extracted. The axis-associated item forming module 120 causes the inter-axis matching module 125 to perform this processing. For example, an item that matches the item classified under the large classification of the hierarchical structure of an already set axis is extracted. As the axis for which items have already been set (hereinafter simply referred to as an “already set axis”), an axis which forms a matrix together with a currently selected axis may be used. For example, if the currently selected axis is the second axis, the already set axis is the first axis. If the currently selected axis is the third axis, the already set axis is the second axis. If the currently selected axis is the fourth axis, the already set axis is the third axis.

In step S912, the axis-associated item forming module 120 displays a list of item names associated with the selected axis name. In this case, only the items extracted in step S910 may be displayed. Alternatively, items other than the items extracted in step S910 may also be included, in which case, the items extracted in step S910 may be displayed in a mode (shape, pattern, color, or a combination thereof) different from that of the other items.

In step S914, the axis-associated item forming module 120 receives one or plural item names.

In step S916, the inter-axis matching module 125 determines whether there is a consistency between one or plural items selected in step S914 and one or plural associated items of the already set axis. If the result of step S916 is YES, the process proceeds to step S920. If the result of step S916 is NO, the process proceeds to step S918. In this case, “having a consistency” means that items have a hierarchical structure and the name of the item associated with the currently selected axis classified under a predetermined level of the hierarchical structure is the same as that associated with the already set axis. The already set axis may be an axis which forms a matrix with a currently selected axis, as stated above. If there is an item that does not match a certain item of the already set axis, the process proceeds to step S918.

In step S918, the axis-associated item forming module 120 corrects the name of the item of the currently selected axis or the already set axis. In this case, the operator is allowed to correct the name of the item of the currently selected axis or the already set axis. However, the operator does not necessarily have to make correction.

In step S920, the axis-associated item forming module 120 adds the received items to a selection list.

In step S922, if necessary, the axis-associated item forming module 120 sorts the selection list.

In step S924, the axis-associated item forming module 120 determines whether the selection of item names has been completed. If the result of step S924 is YES, the process proceeds to step S926. If the result of step S924 is NO, the process returns to step S914.

In step S926, the axis-associated item forming module 120 stores the item names of the selection list in the axis-related information storage module 150 as the item names of the N-th axis.

In step S928, the axis-associated item forming module 120 determines whether N is four. If the result of step S928 is YES, the process proceeds to step S932. If the result of step S928 is NO, the process proceeds to step S930.

In step S930, the axis-name setting module 110 increments N by one (N=N+1).

In step S932, the display module 130 draws a four-axis table by deploying the first axis upward, the second axis rightward, the third axis downward, and the fourth axis leftward.

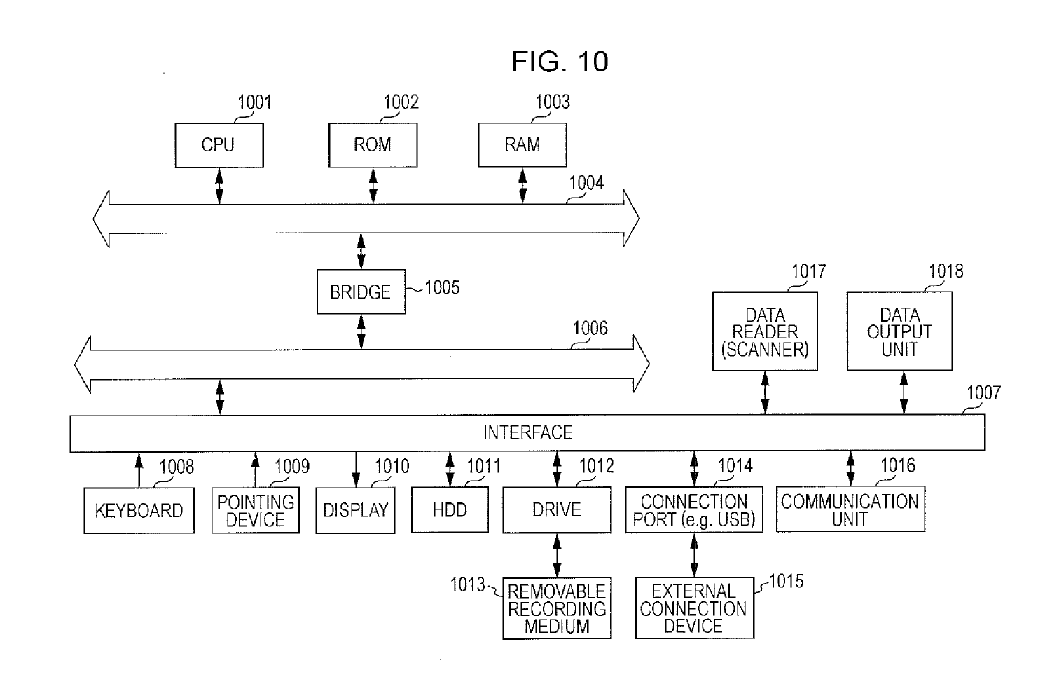

An example of the hardware configuration of the information processing apparatus 100 of this exemplary embodiment will be described below with reference to FIG. 10. The configuration shown in FIG. 10 is an example of the hardware configuration of, for example, a personal computer (PC), including a data reader 1017, such as a scanner, and a data output unit 1018, such as a printer.

A central processing unit (CPU) 1001 is a controller that executes processing in accordance with a computer program which describes an execution sequence of modules discussed in the above-described exemplary embodiment, such as the axis-name setting module 110, the parts/system selecting module 115, the axis-associated item forming module 120, the inter-axis matching module 125, and the display module 130.

A read only memory (ROM) 1002 stores therein programs and operation parameters used by the CPU 1001. A random access memory (RAM) 1003 stores therein a program used during the execution of the CPU 1001 and parameters which vary appropriately during the execution of the CPU 1001. The CPU 1001, the ROM 1002, and the RAM 1003 are connected to one another via a host bus 1004, such as a CPU bus.

The host bus 1004 is connected to an external bus 1006, such as a Peripheral Component Interconnect/Interface (PCI) bus, via a bridge 1005.

A keyboard 1008 and a pointing device 1009, such as a mouse, are input devices operated by an operator. A display 1010, such as a liquid crystal display device or a cathode ray tube (CRT), displays various items of information as text or image information.

A hard disk drive (HDD) 1011 contains a hard disk and drives the hard disk to record or play back information or a program executed by the CPU 1001. In the hard disk, the axis item table 300, set axis names, set item names, etc. are stored. Various other computer programs, such as various data processing programs, are also stored in the hard disk.

A drive 1012 reads data or a program recorded on a removable recording medium 1013 set in the drive 1012, such as a magnetic disk, an optical disc, a magneto-optical disk, or a semiconductor memory, and supplies the read data or program to the RAM 1003 connected to the drive 1012 via an interface 1007, the external bus 1006, the bridge 1005, and the host bus 1004. The removable recording medium 1013 is also usable as a data recording region, which is similar to a hard disk.

A connection port 1014 is a port used for connecting an external connection device 1015 to the PC, and has a connecting portion, such as a Universal Serial Bus (USB) port or an IEEE1394 port. The connection port 1014 is connected to, for example, the CPU 1001, via the interface 1007, the external bus 1006, the bridge 1005, and the host bus 1004. A communication unit 1016 is connected to a communication line and executes data communication processing with external sources. The data reader 1017 is, for example, a scanner, and executes processing for reading documents. The data output unit 1018 is, for example, a printer, and executes processing for outputting document data.

The hardware configuration of the information processing apparatus 100 shown in FIG. 10 is only an example, and this exemplary embodiment may be configured in any manner as long as the modules described in the exemplary embodiment are executable. For example, some modules may be configured as dedicated hardware (e.g., an application specific integrated circuit (ASIC)), or some modules may be installed in an external system and be connected to the PC via a communication line. Alternatively, a system, such as that shown in FIG. 10, may be connected to a system, such as that shown in FIG. 10 via a communication line, and may be operated in cooperation with each other.

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, e.g., it may be compressed or encrypted, as long as it can be reconstructed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an axis-name setting unit that sets names of first through fourth axes;
an item forming unit that forms an item associated with an axis for which a name is set by the axis-name setting unit; and
a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein the item forming unit forms items associated with the first through fourth axes as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

2. An information processing apparatus comprising:
an axis-name setting unit that sets names of first through fourth axes;
an item forming unit that forms an item associated with an axis for which a name is set by the axis-name setting unit; and
a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein the item forming unit forms items associated with the first through fourth axes as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

3. The information processing apparatus according to claim 1, wherein the axis-name setting unit displays an axis name list for the operator, and sets names selected from the axis name list by the operator as the names of the axes.

4. The information processing apparatus according to claim 2, wherein the axis-name setting unit displays an axis name list for the operator, and sets names selected from the axis name list by the operator as the names of the axes.

5. The information processing apparatus according to claim 1, wherein the item forming unit displays an item list for the operator, and sets items selected from the item list by the operator as the items associated with the axes.

6. The information processing apparatus according to claim 2, wherein the item forming unit displays an item list for the operator, and sets items selected from the item list by the operator as the items associated with the axes.

7. The information processing apparatus according to claim 3, wherein the item forming unit displays an item list for the operator, and sets items selected from the item list by the operator as the items associated with the axes.

8. The information processing apparatus according to claim 4, wherein the item forming unit displays an item list for the operator, and sets items selected from the item list by the operator as the items associated with the axes.

9. The information processing apparatus according to claim 1, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

10. The information processing apparatus according to claim 2, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

11. The information processing apparatus according to claim 3, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

12. The information processing apparatus according to claim 4, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

13. The information processing apparatus according to claim 5, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

14. The information processing apparatus according to claim 6, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

15. The information processing apparatus according to claim 7, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

16. The information processing apparatus according to claim 8, wherein:
the items associated with the axes have a hierarchical structure; and
the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

17. An information processing method comprising:
setting names of first through fourth axes;
forming an item associated with an axis for which a name is set; and
displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein items associated with the first through fourth axes are formed as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

18. An information processing method comprising:
setting names of first through fourth axes;
forming an item associated with an axis for which a name is set; and
displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein items associated with the first through fourth axes are formed as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

19. A non-transitory computer readable medium storing a program causing a computer to execute a process, the process comprising:
setting names of first through fourth axes;
forming an item associated with an axis for which a name is set; and
displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein items associated with the first through fourth axes are formed as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

20. A non-transitory computer readable medium storing a program causing a computer to execute a process, the process comprising:
setting names of first through fourth axes;
forming an item associated with an axis for which a name is set; and
displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,
wherein items associated with the first through fourth axes are formed as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.
